(19) United States
(12) Patent Application Publication
(10) Pub. No.: US 2017/0120670 A1
(43) Pub. Date: May 4, 2017

(54) Automobile Tire And Rim Anti-Theft Device

(71) Applicants: David A. Patterson, Union City, GA (US); Donald Anthony Muntner, Loganville, GA (US); Christopher Scott Kudika, Suwanee, GA (US); James Noah McNeely, Grayson, GA (US)

(72) Inventors: David A. Patterson, Union City, GA (US); Donald Anthony Muntner, Loganville, GA (US); Christopher Scott Kudika, Suwanee, GA (US); James Noah McNeely, Grayson, GA (US)

(21) Appl. No.: 15/339,653

(22) Filed: Oct. 31, 2016

Related U.S. Application Data
(60) Provisional application No. 62/248,003, filed on Oct. 29, 2015.

(51) Int. Cl. B60B 7/16

(52) U.S. Cl. CPC B60B 7/16; B60B 2900/3318

(57) ABSTRACT

An anti-theft device for preventing the theft of tires and rims on automobiles. The anti-theft device may be secured over the rim of an automobile so that the anti-theft device is secure and covers the lug nuts of the wheel. The anti-theft device prevents access to the lug nuts and thus prevents the lug nuts and consequently the wheel from being removed. The anti-theft device may include a housing, security cables, a locking mechanism, and a lock.

### CROSS-REFERENCE TO RELATED APPLICATION

This application claims the benefit of U.S. Provisional Patent Application Ser. No. 62/248,003, filed on Oct. 29, 2015, entitled “Automobile Tire and Rim Anti-Theft Device,” the content of which is incorporated by reference herein in its entirety.

### TECHNICAL FIELD

Embodiments disclosed herein generally relate to anti-theft devices, specifically devices that prevent the theft of automobile tires and rims.

### BACKGROUND

Tires are secured to a car by a rim and lug nuts attached to lugs on a wheel. The rim provides the structural support for the tires, and 4-6 lug nuts are typically used to bolt the rim to the wheel. This method of securing tires to cars has been in use for decades.

Tires and rims are expensive, ranging from hundreds to even thousands of dollars for a full set. One major problem with the design, however, is that it leaves tires and rims subject to theft. This type of theft is quite common and easy. A thief would need only a car jack, lug nut wrench, and mere minutes to remove all the rims and tires from a car. A thief could simply lift the car using the car jack, unscrew the lug nuts with the lug nut wrench, and remove the tire and rim. While there exist locking lug nuts that require a key to loosen, such locking lug nuts (or the lugs to which they are attached) are breakable with a fair amount of force. Some car owners invest thousands of dollars into more expensive after-market tires and rims, but that often makes them more attractive targets for theft.

A solution is needed to provide a way to prevent tire and rim theft on automobiles. The present disclosure addresses these needs.

### SUMMARY

The present disclosure is directed toward an anti-theft device that comprises a housing and at least one security cable. The housing comprises a locking mechanism, at least two entry points, and a lock. The housing may be placed over the lug nuts used to secure a rim to a car. The cable may be secured to the housing at one end. The other end may wrap around one or more spokes of a rim and enter back into the housing through an entry point. A locking mechanism inside the housing may secure the cable so that the housing remains securely pressed up against the lug nuts. Multiple cables may be used to ensure the housing is secure.

The cables may be made of flexible braded steel cables. The cables may also be made of any other strong and durable material suitable for this purpose. The cables may be flexible or rigid. The cables may have notches or holes that allow the locking mechanism to secure the cables inside the housing. One end of the cables may be fixed inside the housing while the other may be removable. It is also possible that both ends of the cables are removable and can be secured with a locking mechanism. The cables may be covered in a layer or layers of rubber, plastic, or any other soft, durable material. The layer surrounding the cable may be used to reinforce the cables. The layer may also be used to protect the rim from damage that may be caused by the cables.

The housing may be made of any hard, durable material, such as steel, iron, or titanium. The housing may be any shape so long as it fits over the lug nuts securing the rim to the car. It can be appreciated that different size housings may be necessary for different size rims. The housing may also be any shape, such as a square, circle, triangle, or rectangle.

The locking mechanism may be used to secure the cable inside the housing. The lock and locking mechanism may be separate devices that are connected by a connector, or they may be part of the same device. There may be one single locking mechanism inside of the housing or there may be multiple locking mechanisms. The lock may be used to secure or release the locking mechanism. The lock may be a key and lock, combination lock (either mechanical or electronic), or some other type of electronic lock, such as using a key fob or cellular device.

In an aspect, the anti-theft apparatus for a rim includes a housing having a base, the base sized to fit over at least a portion of a hub of the rim, the housing defining a hole therethrough, a piston positioned within the hole, the piston moveable axially and rotatably within the hole, a security cable connected to the piston, a distal end of the security cable having a lip formed thereon, wherein the security cable moves with the axial movement of the piston, a locking mechanism within the housing, wherein the locking mechanism is activated upon the axial movement of the piston away from the base, and a lock connected to the locking mechanism. The locking mechanism may be fixed upon the rotational movement of the piston. The anti-theft apparatus may also include handle attached to the distal end of the piston away from the base, a ring attached to the piston through cooperating threads such that the position of the piston relative to the base is adjustable. The anti-theft apparatus may also include the lip being sized to contact the interior of a spoke. In an aspect, the apparatus may also have a buffer material attached to the base.

In another aspect of the disclosure, there is an anti-theft apparatus for a rim, including, hiding means for covering at least one lug nut, securing means for connecting the hiding means to the rim, tightening means for pushing the hiding means closer to the rim, and locking means for preventing the removal of the hiding means. The apparatus may also include rotation means for rotatably moving the tightening means to engage a locking mechanism. The securing means may also include a connection to the rim which may be one of a loop, a J-shaped portion, an L-shaped portion and a T-shaped portion. The securing means includes security cables. The hiding means comprises a housing having a hole therethrough and the tightening means comprises a piston axially moveable within the hole.

The disclosure is also directed to a method for securing an anti-theft device on a rim, comprising positioning a cover over at least one lug nut on the rim, securing the cover onto the rim using at least one security cable, tightening the cover, and engaging a locking mechanism for the cover, and locking the cover. The method may include wherein tightening the cover includes pulling the security cable away from the rim prior to locking the cover.

The anti-theft device can be used to effectively prevent the theft of tires and rims on an automobile. When the disclosed anti-theft device is placed securely over the lug nuts of an automobile, the lug nuts cannot be removed, thus preventing theft. The anti-theft device can be easily removed by releasing the locking mechanism so that the car is not driven with the anti-theft device attached.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Furthermore, the claimed subject matter is not limited to embodiments that solve any or all disadvantages noted in any part of this disclosure.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings, wherein like numerals refer to like components or steps:

FIG. 1 illustrates an automobile on which a device constructed in accordance with the present disclosure may be implemented;

FIG. 2 illustrates a typical rim and lug nuts for an automobile such as that in FIG. 1;

FIG. 3 illustrates an embodiment of the anti-theft device described in the present disclosure;

FIG. 4 further illustrates the housing of the anti-theft device shown in FIG. 3;

FIG. 5 further illustrates the cable of the anti-theft device shown in FIG. 3;

FIG. 6 illustrates the cross section of a cable similar to the cable shown in FIG. 5;

FIG. 7 illustrates the locking mechanism of the anti-theft device shown in FIG. 3;

FIG. 8 illustrates an embodiment of the anti-theft device of FIG. 3 attached to a rim;

FIG. 9 illustrates another embodiment of an anti-theft device similar to the anti-theft device of FIG. 3 as attached to a rim;

FIG. 10 illustrates a method for attaching the anti-theft device of FIG. 3 to a rim;

FIG. 11 is a perspective view of another embodiment of the anti-theft device described in the present disclosure;

FIG. 12 is a cross-sectional view of the anti-theft device shown in FIG. 11;

FIG. 13 is a top view of the anti-theft device shown in FIG. 11;

FIG. 14 is a side view of the anti-theft device shown in FIG. 11; and

FIG. 15 illustrates a method of attaching the anti-theft device shown in FIG. 11 to a rim.

### DETAILED DESCRIPTION OF ILLUSTRATIVE EMBODIMENTS

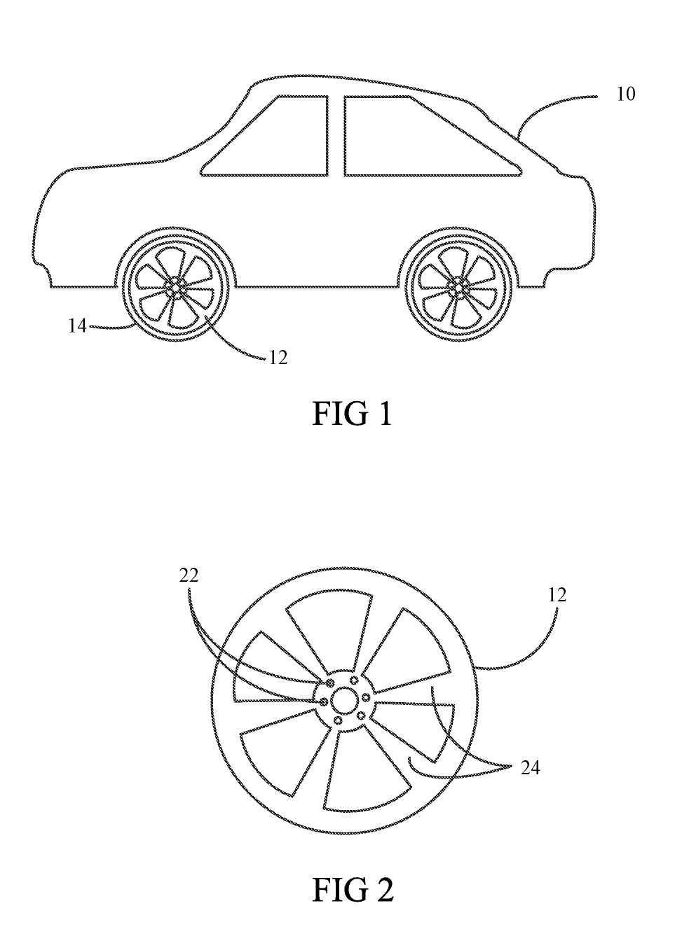

As described herein, FIG. 1 illustrates an automobile 10 on which an anti-theft device constructed in accordance with the present disclosure may be implemented. There is shown automobile 10, which further includes multiple rims 12 and tires 14. Automobile 10 may be any type of vehicle that includes rims 12 and tires 14, such as a car, truck, or other vehicle. Rim 12 may be used to secure tire 14 to a wheel (not shown) of automobile 10. In addition to being functional, the rims also serve an aesthetic purpose.

FIG. 2 is a more detailed illustration of rim 12 of FIG. 1. Rim 12 comprises spokes 24 and lug nuts 22 wherein spokes 24 extend from center hub of the rim 12 to the outer circumference of rim 12. Spokes 24 provide structural sport for rim 12 as well as create aesthetic appeal. Lug nuts 22 are attached to lugs (not shown) which are integral to a wheel on automobile 10 and which pass through holes in the center section of the hub of rim 12 as is known in the art.

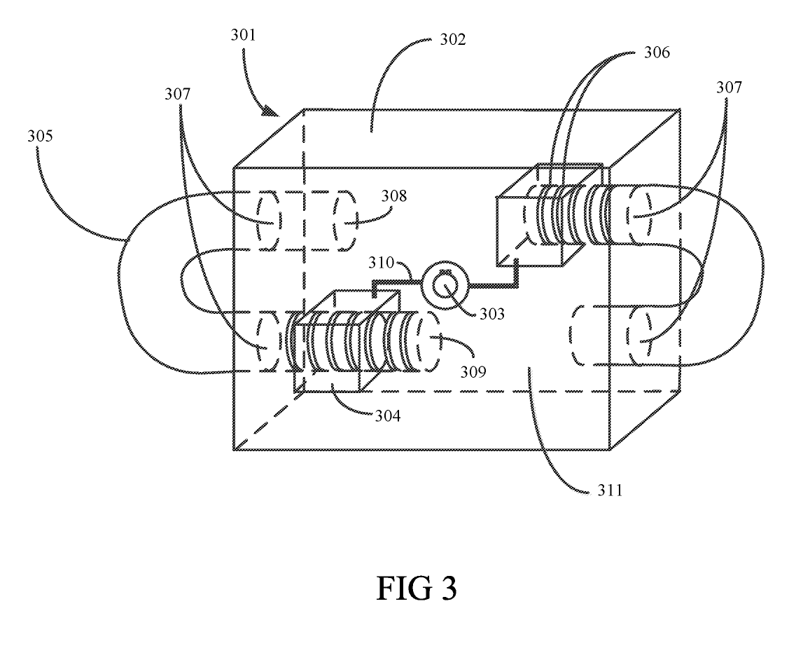

FIG. 3 illustrates an embodiment of anti-theft device 301. Anti-theft device 301 may be configured to be attached to rim 12 of automobile 10 in a way such that one or more of lug nuts 22 are not accessible and therefore cannot be removed. As set forth in more detail below, anti-theft device 301 may include housing 302, lock 303, locking mechanism 304, security cable 305, cable grooves 306, entry points 307, and connector 310. It will be appreciated that anti-theft device 301 may include any sub-combination of the foregoing elements while remaining consistent with the present disclosure. Housing 302 is that component of an anti-theft device 301 that, when attached to rim 12, covers one or more of lug nuts 22 to prevent external access to one or more lug nuts 22.

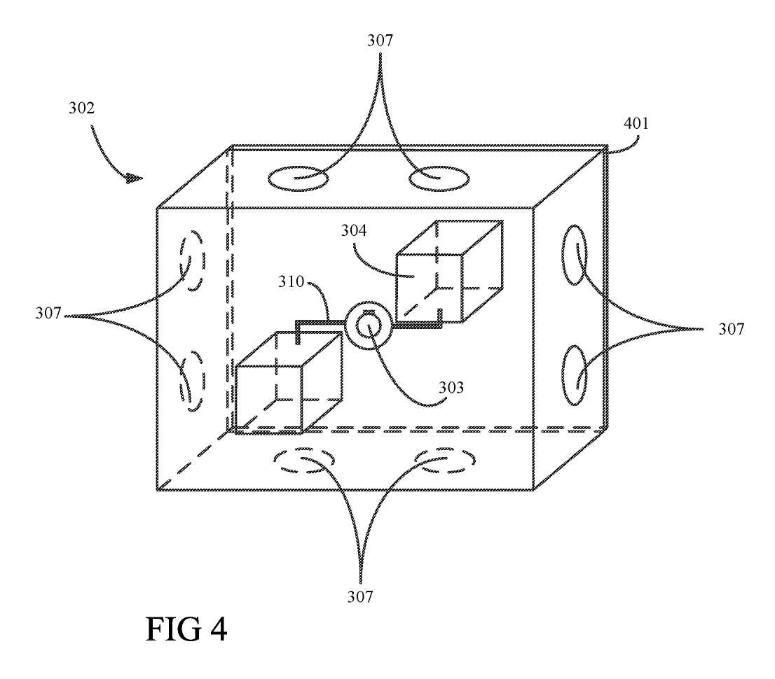

With reference to FIG. 4, housing 302 may be any device that includes lock 303 and locking mechanism 304. Housing 302 may be square, rectangular, circular or any other shape. Lock 303 may be accessible from front 311 of housing 302 and lock 303 may be operable by a key, a combination, a biometric reading of a fingerprint or other biological attribute, electronically via a Bluetooth or other connection to a cellular device or key fob, or any other of type of locking/unlocking scheme. Lock 303 may be connected to locking mechanism 304 through connectors 310. In operation, turning or otherwise activating lock 303 will cause connectors 310 to engage or disengage locking mechanisms 304. Housing 302 may also include entry points 307 defined as holes in housing 302 wherein such entry points 307 are configured to receive security cable 305. Note that there may be multiple entry points 307 into housing 302 to accommodate multiple security cables 305. Housing 302 may be made of steel, stainless steel, titanium, aluminum, or any other durable material. Housing 302 may be sized such as to cover one or more lug nuts 22 on rim 12

Housing 302 may also comprise protective layer 401. Protective layer 401 may allow housing 302 to be positioned flush against rim 12, and it may also serve as a protective layer so that housing 302 does not scratch or otherwise damage rim 12. Protective layer 401 may be made of rubber, foam, or any other type of known protection or padding material. Front 311 of housing 302 may be sized and shaped to accommodate a logo or other markings, such as the name of the anti-theft device 301 or the name of the manufacturer or seller of rims 12 or tires 14.

Referring again to FIG. 1, security cable 305 may be used as means to connect housing 302 to rim 12. Each security cable 305 has two ends, a first end 308 and a second end 309. Security cable 305 may be configured to enter through entry points 307 in housing 302 and be secured in housing 302 using locking mechanism 304. One end of security cable 305 may be permanently attached to or integrally formed with housing 302 on first end 308 and be removably attached to locking mechanism 304 within housing 302 on second end 309. In an alternative embodiment, first end 308 and second end 309 of security cable 305 may both be removably connected to one or more locking mechanisms 304 within housing 302.

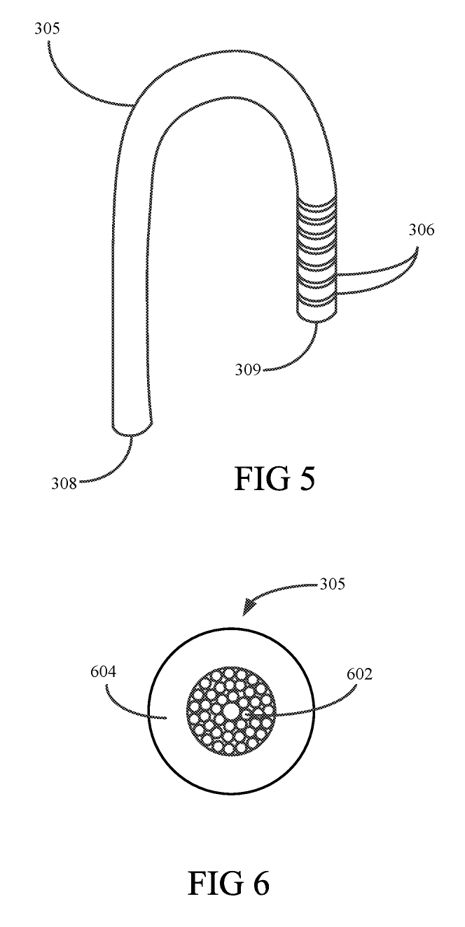

With reference to FIG. 5, second end 309 of security cable 305 may be configured to be received by a connector in locking mechanism 304 and releasable using lock 303. Second end 309 of security cable 305 may include grooves 306 of security cable 305 which interact with cooperating grooves within locking mechanism 304. In an aspect, first end 308 and second end 309 both have grooves 306. In this case, both ends 308 and 309 are removable from housing 302. Security cable 305 may be flexible or rigid, and in either case may be able to secure housing 302 to spokes 24, and be made of any suitable material that is resistant to cutting. Security cable 305 may be of sufficient length as to wrap around spokes 24 of rim 12 and also be able to be tightly connected to locking mechanism 304 so as to not permit tampering with or cutting of security cable 305 without damaging the rims.

FIG. 6 illustrates an embodiment of a cross section of security cable 305. Security cable 305 may comprise inner layer 602 and outer layer 604. Inner layer 602 may be steel cable, flexible braided steel cable, or any other type of durable and flexible material that would allow security cable 305 to wrap around one of spokes 24 of rim 12. Outer layer 604 may be a protective layer made of rubber, plastic, foam, or any other known flexible protective material. Outer layer 604 may provide added protection to make security cable 305 more difficult to cut, and outer layer 604 may be a protective layer to prevent security cable 305 from damaging rim 12. Security cable 305 may also include just a single layer or more than 2 layers.

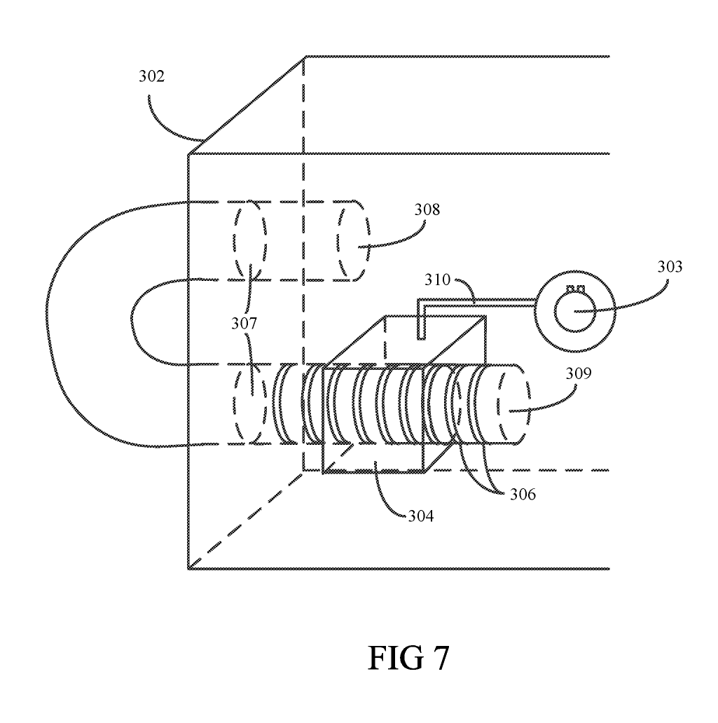

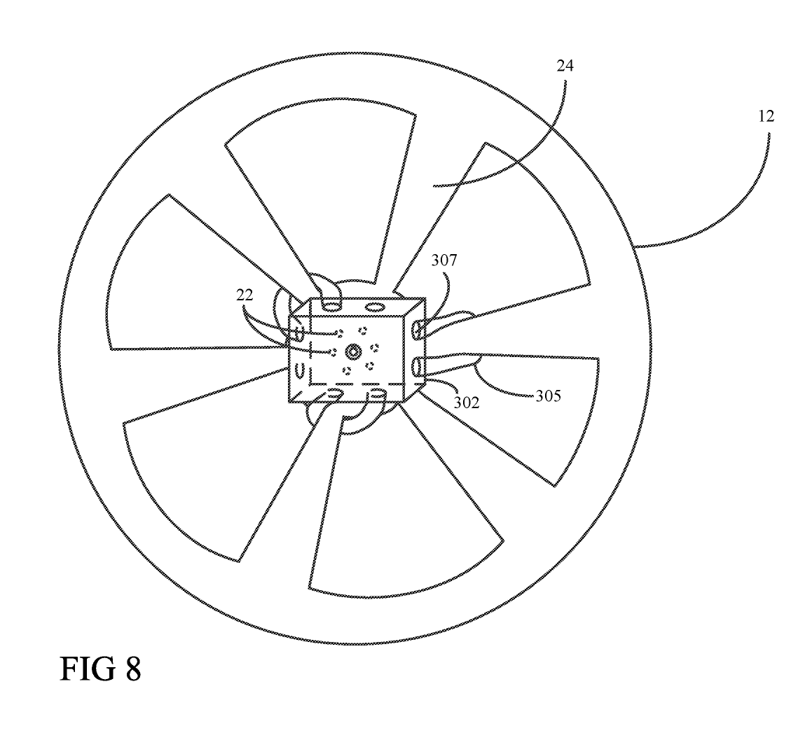

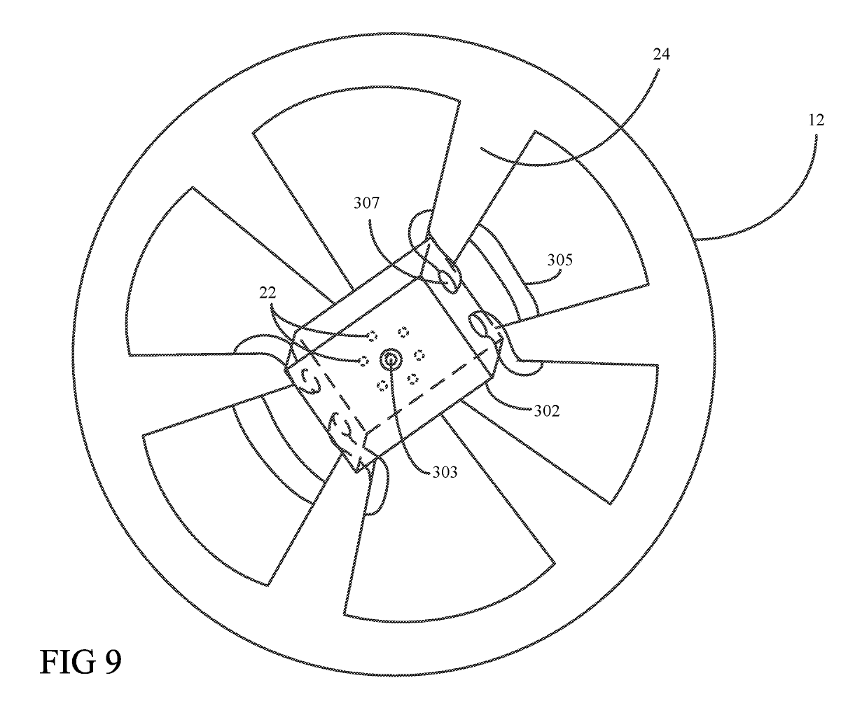

FIG. 7 illustrates an embodiment of lock 303 and locking mechanism 304. Locking mechanism 304 may be disposed inside housing 302. Locking mechanism 304 may be any mechanism that can secure security cable 305 inside of housing 302. Locking mechanism 304 may secure security cable 305 automatically when second end 309 of security cable 305 is inserted into housing 302 through entry point 307, or locking mechanism 304 may secure security cable 305 only when lock 303 is activated by lock 303. Locking mechanism 304 may only release security cable 305 when activated by lock 303. It will be appreciated that lock 303, locking mechanism 304, and connector 310 may include any sub-combination of the foregoing elements while remaining consistent with the present disclosure. For example, lock 303 may be connected directly to locking mechanism 304, thus eliminating the need for connector 310. Lock 303 may be connected to all locking mechanism 304 in housing 302, but each locking mechanism 304 may also be connected to its own lock 303.

It will be appreciated that there are other means for connecting security cable 305 with housing 302 consistent with the present disclosure. For example, security cable 305 may comprise grooves onto which locking mechanism 304 attaches. Security cable 305 may have holes into which locking mechanism 304 inserts a stopping device, such as a rod. Locking mechanism 304 may simply apply a strong compression force on security cable 305 and use the friction to secure security cable 305. The combination of security cable 305 and locking mechanism 304 may have a quick release connector. Security cable 305 may pass through locking mechanism 304 or security cable 305 may attach directly into locking mechanism 304. It can be appreciated that there are numerous other known methods in which locking mechanism 304 can secure security cable 305 inside of housing 302.

Lock 303 may comprise a physical key and lock to release locking mechanism 304. Lock 303 may also be a combination lock that only releases locking mechanism 304 when the correct combination is entered. The combination lock may be mechanical or electrical. Lock 303 may also release locking mechanism 304 using a cable-less device, such as a key fob sensor or a cellular device. It can be appreciated that there are numerous other means by which lock 303 can secure or release locking mechanism 304.

For example, in an aspect, housing 302 may comprise one locking mechanism 304 and one lock 303. Housing 302 may have two security cables 305 permanently connected to it on opposite sides of housing 302. After being wrapped around spoke 24, second end 309 of security cables 305 may be inserted into housing 302 through entry points 307. Inside housing 302, security cables 305 are guided to locking mechanism 304. In this example locking mechanism 304 may have the capability to secure two cables simultaneously. Lock 303 could activate locking mechanism 304 to release both security cables 305 simultaneously. In another aspect, housing 302 comprises two locking mechanisms 304 and two security cables 305. In this example each security cable 305 can connect to its own locking mechanism 304. Housing 302 can further comprise one lock 303 that can activate both locking mechanisms 304 via connector 310, or housing 302 can comprise two locks 303 that connect to their own respective locking mechanism 304. In another aspect, housing 302 may comprise three or more security cables 305 that connect to the same locking mechanism 304, share locking mechanisms 304, or each connect to its own locking mechanism 304.

In an aspect, security cables 305 may not be not permanently connected to housing 302. Security cables 305 may have grooves 306 along first end 308 as well as second end 309. Security cables 305 may also have grooves along the entire length of security cables 305. First end 308 of security cables 305 may be inserted into housing 302 through entry points 307. First end 308 of security cables 305 may insert into and be secured by locking mechanisms 304. Second end 309 of security cables 305 may be wrapped around spokes 24 and back into housing 302 through entry points 307 such that housing 302 covers lug nuts 22. Second end 309 of security cables 305 may be secured by the same locking mechanism 304 as their corresponding first end 308. Second end 309 may also be secured by its own separate locking mechanism 304. Both first end 308 and second end 309 of security cables 305 may connect to the same locking mechanism 304. In an aspect, housing further comprises a type of crank (not shown) to allow security cables 305 to be tightened easier and more effectively than a user by himself.

With respect to FIG. 8, anti-theft device 301 may be placed over rim 12 such that one or more lug nuts 22 are covered and thereby not accessible with anti-theft device 301 attached. Security cables 305 may originate from housing 302, wrap around spokes 24, and be reinserted into housing 302 through entry point 307 where security cables 305 may be secured. In FIG. 8, anti-theft device 301 comprises three security cables 305 that each wrap around an individual spoke 24. Security cables 305 may be secured tight enough so that lug nuts 22 cannot be exposed. This will prevent a potential thief from being able to remove lug nuts 22 and steal rim 12.

FIG. 9 illustrates another embodiment of how anti-theft device 301 may be used in conjunction with rim 12. Anti-theft device 301 may be placed over rim 12 such that lug nuts 22 are covered. Security cables 305 may originate from housing 302, wrap around spokes 24, and reinserted into housing 302 through entry point 307, where security cables 305 may be secured. In FIG. 9, anti-theft device 301 comprises two security cables 305 that each wrap around two spokes 24 before reinserting into housing 302. Security cables 305 may be secured so that lug nuts 22 are not exposed and therefore not accessible. It can be appreciated that there can be numerous other configurations in which anti-theft device 301 can be secured to rim 12.

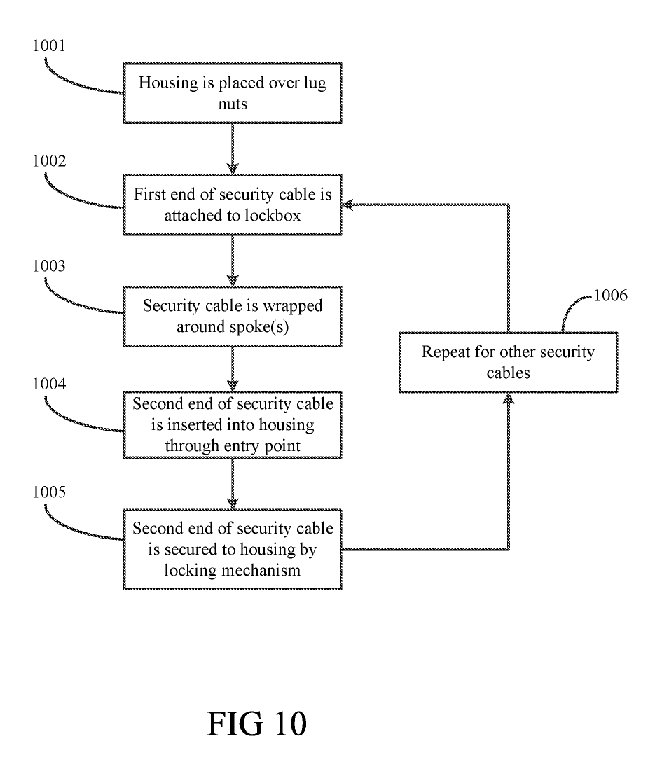

FIG. 10 illustrates a method for securing anti-theft device 301 to rim 12. At 1001, housing 302 may be placed over lug nuts 22. At 1002, first end 308 of security cable 305 may be attached to housing 302. At 1003, security cable 305 may be wrapped around one or more of spokes 24. At 1004, second end 309 of security cable 305 may be inserted into housing 302 through entry point 307. At 1005, second end 309 of security cable 305 may be secured to housing 302 by locking mechanism 304. At 1006, 1002-1005 are repeated for any other security cable(s) 305. Removing anti-theft device 301 is accomplished by unlocking locking mechanism 304 and removing security cable(s) 305.

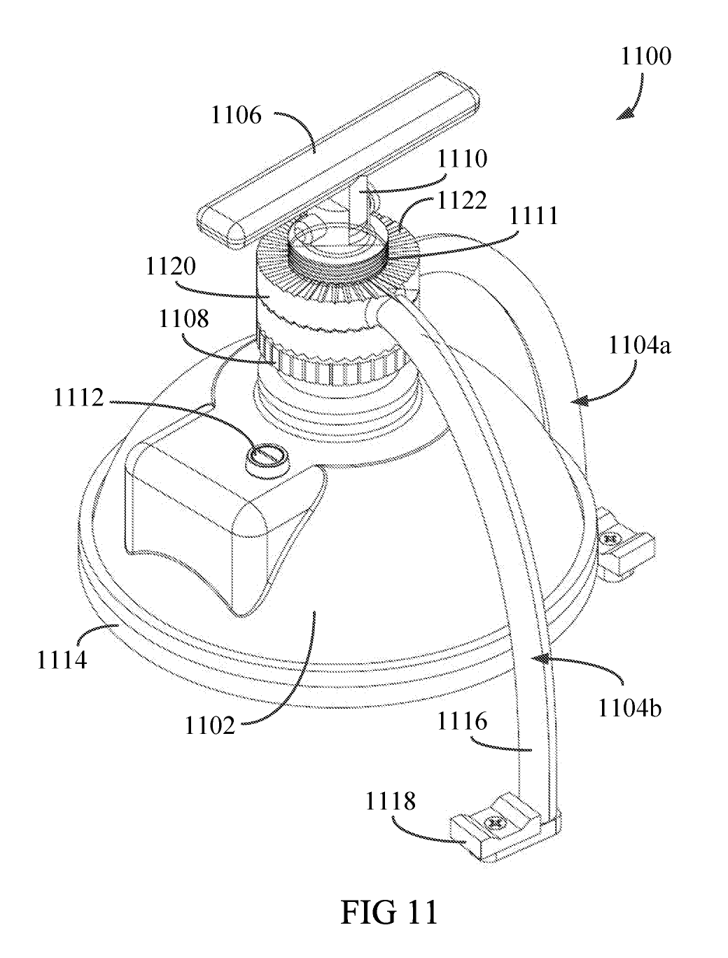

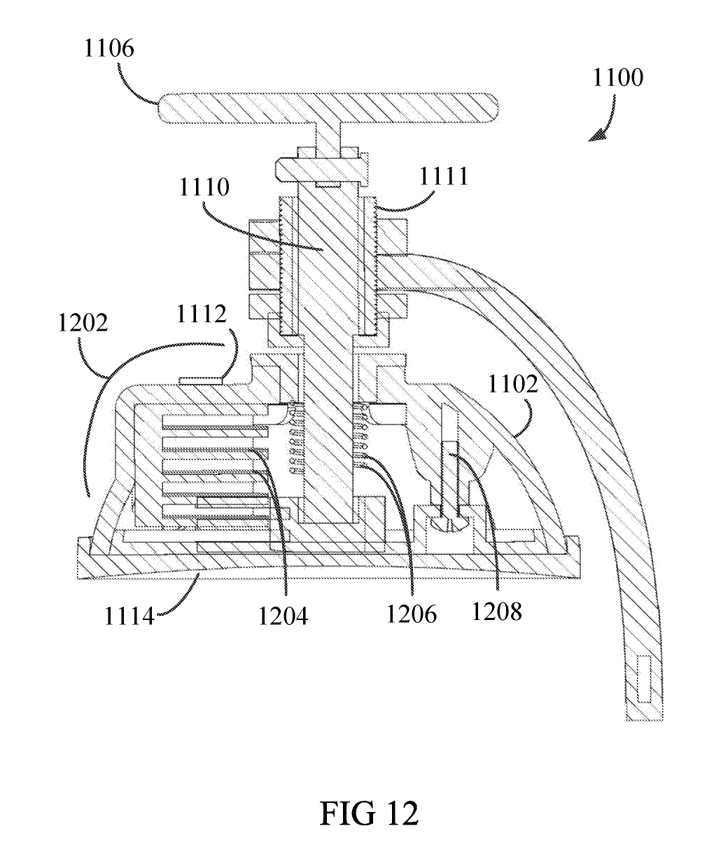

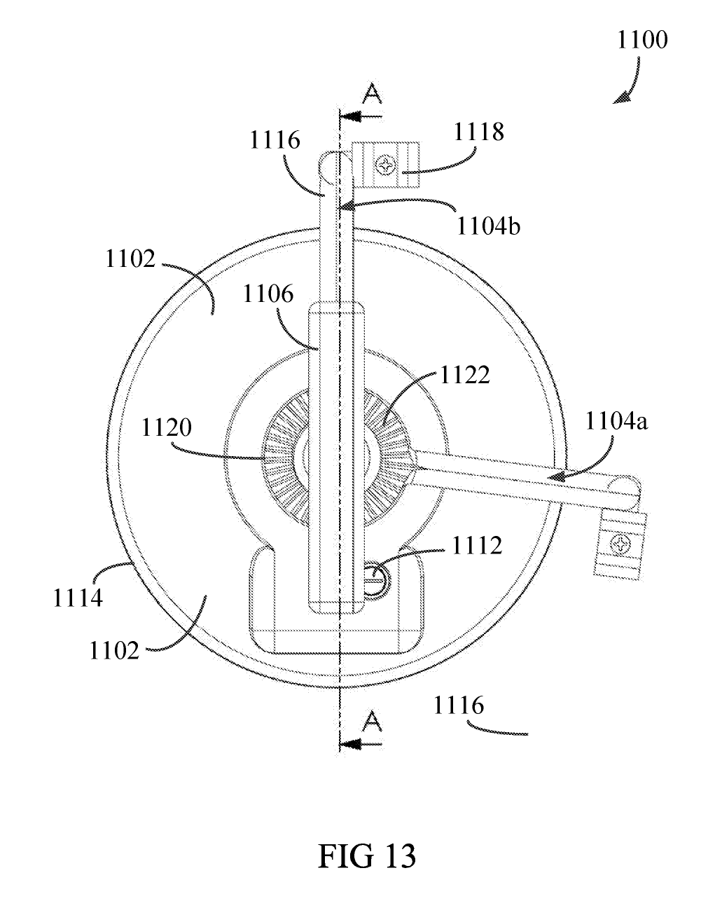

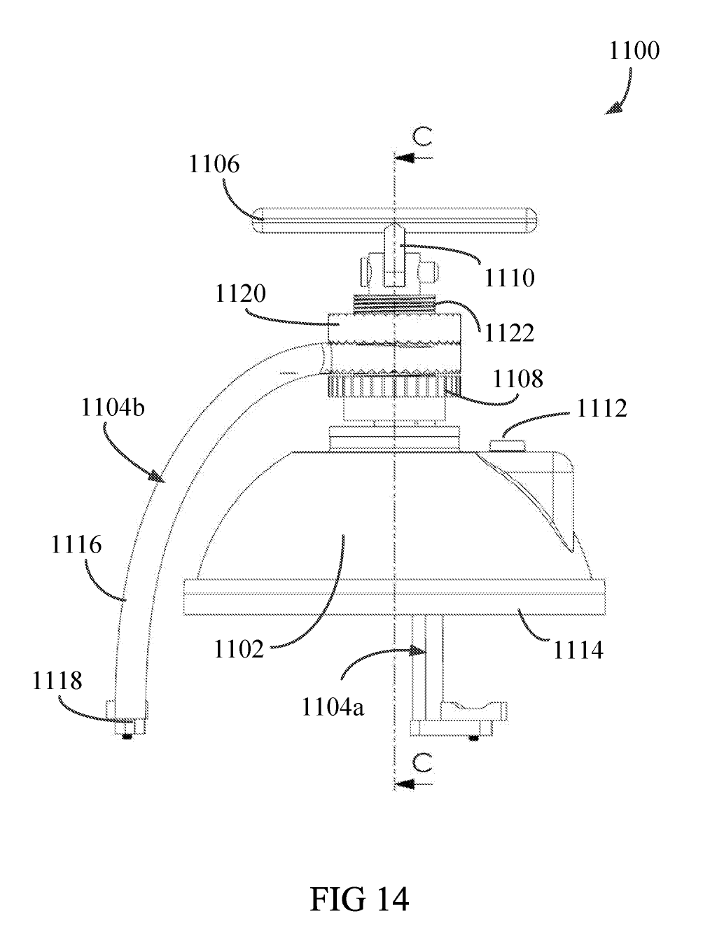

Turning to alternative embodiments of a device constructed in accordance with the present disclosure shown in FIGS. 11-14, FIG. 11 illustrates a perspective view of an alternative embodiment showing anti-theft device 1100, while FIGS. 12, 13, and 14 show a cross-sectional view, a top view, and a side view of anti-theft device 1100, respectively. Anti-theft device 1100 may include housing 1102, security cables 1104a and 1104b, handle 1106, adjustment knob 1108, piston 1110, lock 1112, and base 1114.

Housing 1102 may be made of a hard, durable material, such as reinforced aluminum, steel, stainless steel, or the like. Housing 1102 may be sized to have a diameter smaller than the diameter of rim 12 of FIG. 1. Housing 1102 may be sufficiently large that it may cover one or more lug nuts 22 that secure rim 12 to automobile 10. Housing 1102 may be of any shape and may, for example, be shaped similar to a half sphere. It is contemplated that housing 1102 may be of other shapes and sizes that still achieve the desired function of covering lug nuts 22 on rim 12 and being secured to rim 12. While housing 1102 shown is solidly formed, housing 1102 may also have holes formed therein in areas where lug nuts 22 are not exposed in order to reduce weight or for other aesthetic or functional purposes.

Piston 1110 may pass through a hole formed through housing 1102 and be axially and rotatably adjustable therein as shown in FIG. 12. Piston 1110 may be made of a hard, durable material, such as reinforced aluminum, steel, stainless steel, or the like. Piston 1110 may include grooves 1111 on at least a portion of piston 1110. Piston 1110 may be spring loaded. Handle 1106 may be affixed to the distal end of piston 1110 opposite base 1114. In an example, handle 1106 may allow a user to rotate piston 1110 to release a spring and thereby extend piston 1110 away from housing 1102. This will be described later in more detail.

Handle 1106 may be constructed to be a break-away handle so as to withstand a predetermined amount of force before breaking. When a force greater than the predetermined amount of force is exerted on handle 1106, handle 1106 may break away while anti-theft device 1100 remains operable. This may prevent a thief from attempting to break anti-theft device 1100. Handle 1106 may be built or configured to withstand a smaller amount of force than would be necessary to break anti-theft device 1100, thereby preventing the thief from accessing rim 12 to which anti-theft device 1100 is attached.

Each of security cables 1104a-b may include arm portion 1116, latching portion 1118, and cylindrical portion 1120. Security cables 1104a-b may be made of a hard, durable material, such as reinforced aluminum, steel, stainless steel, or the like. Cylindrical portion 1120 may be cylindrically shaped and contain grooves 1122 on the top and bottom of cylindrical portion 1120. When cylindrical portion 1120 of security cables 1104a and 1104b are disposed adjacent each other as shown in FIG. 11, grooves 1122 of cylindrical portion 1120 of security cables 1104a and 1104b may interlock, preventing security cables 1104a and 1104b from rotating relative to each other. Security cables 1104a and 1104b may be rotated relative to each other only when grooves 1122 of each of security cables 1104a-b are separated (i.e. not interlocked). This may be done, for example, to adjust the relative distance of the top of security cables 1104a-b from base 1114 to fit the spokes and hub pattern of rim 12. In an alternative embodiment, arm portion 1116 may be a chain and latching portion 1118 may be an end link on a chain with a hook that can hook around an edge of rim 12. Although two security cables 1104a-b are illustrated in the embodiment, it can be appreciated that anti-theft device 1100 may include just one or more than two security cables 1104a-b.

Arm portion 1116 may extend from cylindrical portion 1120 and curve at approximately the same curvature of housing 1102. Latching portion 1118 may be disposed at an end of arm portion 1116 opposite of cylindrical portion 1120. Latching portion 1118 may be shaped to fit securely around a spoke of rim 12 or behind a spoke or multiple spokes.

Adjustment knob 1108 may be disposed between security cables 1104a-b and housing 1102. Adjustment knob 1108 may be cylindrically shaped. Piston 1110 and adjustment knob 1108 may each include grooves 1111 such that adjustment knob 1108 may be moved along piston 1110 by rotating adjustment knob 1108, similar to a nut and bolt apparatus. When adjustment knob 1108 is set to a desired position on piston 1110, adjustment knob 1108 may prevent security cables 1104a-b from moving along piston 1110 toward housing 1102.

Base 1114 may be affixed to housing 1102 opposite of security cables 1104a-b, adjustment knob 1108, and handle 1106. Base 1114 may be composed of a durable, but flexible material, such as rubber, a durable foam material, or the like. Base 1114 may serve as a protective barrier between anti-theft device 1100 and rim 12 of automobile 10 when anti-theft device 1100 is secured to rim 12. Base 1114 may be flexible so that anti-theft device 1100 can securely attach to flat, concave, or convex rims.

FIG. 12 illustrates a cross-sectional view of anti-theft device 1100. Shown in FIG. 12 is locking mechanism 1202. Locking mechanism 1202 may be disposed inside of housing 1102. Locking mechanism 1202 may include piston 1110, handle 1106, lock 1112, lock rods 1204, and latch rods 1206. When locking mechanism 1202 is engaged, lock rods 1204 overlap with latch rods 1206, preventing piston 1110 from moving. When lock 1112 is not engaged, lock rods 1204 do not overlap with latch rods 1206, and piston 1110 can be moved or adjusted. Locking mechanism 1202 may be engaged or disengaged by extending piston 1110 such that handle 1106 is extended away from housing 1102. When piston 1110 is fully or near fully extended, piston 1110 may be rotated, resulting in lock rods 1204 and latch rods 1206 overlapping and securing piston 1110. Locking mechanism 1202 may then be engaged.

Handle 1106 may be used to facilitate the rotating of piston 1110 to engage locking mechanism 1202. Locking mechanism 1202 may be locked using lock 1112. When lock 1112 is in a locked state, piston 1110 cannot be rotated and locking mechanism 1202 therefore remains engaged. Unlocking lock 1112 may allow piston 1110 to be rotated such that locking mechanism 1202 is no longer engaged. Lock 1112 may be any type of known locking engagement mechanism, such as a key, combination lock (either mechanical or electronic), or some other type of electronic lock, such as using a key fob or cellular device, biometric authentication, or the like. FIG. 12 also illustrates bolt 1208 that secures base 1114 to housing 1102.

In an example, anti-theft device 1100 may have two states: engaged and disengaged. When anti-theft device 1100 is disengaged, locking mechanism 1202 may also be disengaged so that piston 1110 may be adjustable. Security cables 1104a-b may be free to be moved along piston 1110 between adjustment knob 1108 and handle 1106. Adjustment knob 1108 may be rotated along piston 1110.

When anti-theft device 1100 is engaged, anti-theft device 1100 may be placed on the outside of rim 12 so that base 1114 covers as least one lug nut 22 of rim 12. Latching portion 1118 of security cables 1104a-b may be disposed around spokes 24 of rim 12 and fit behind spokes 24 on the interior of spokes 24. Piston 1110 may be fully extended with handle 1106 pulled away from housing 1102. Locking mechanism 1202 may be engaged and locked as described above. Adjustment knob 1108 may be set at a predetermined position such that, with piston 1110 fully extended, anti-theft device 1100 is securely attached to rim 12. Security cables 1104a-b may exert a force toward base 1114 and latching portion 1118 of security cables 1104a-b may exert an opposite force on the interior of rim 12. The opposing forces may effectuate a clamp-like mechanism that keeps anti-theft device 1100 device securely attached to rim 12.

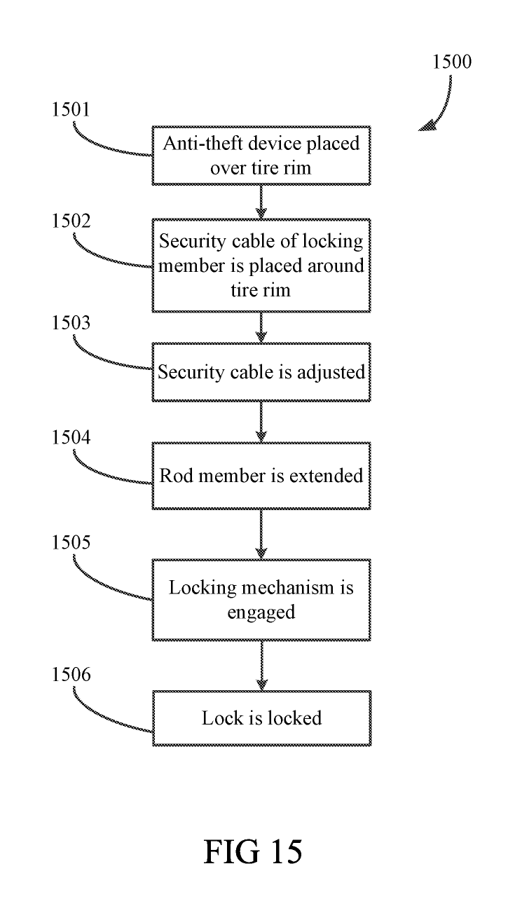

FIG. 15 illustrates a method 1500 of securing anti-theft device 1100 to rim 12 of FIG. 1. At 1501, anti-theft device 1100 is placed over rim 12. Anti-theft device 1100 may be placed so that base 1114 is in contact with the rim 12 and anti-theft device 1100 covers at least one lug nut 22 of rim 12. At 1502, latching portion 1118 of security cables 1104a-b are placed behind spokes 24 on rim 12. As an example, each latching portion 1118 may be placed behind a spoke 24 of rim 12 or in an alternative embodiment, may be a loop that encircles a spoke 24 of rim 12. At 1503, adjustment knob 1108 may be adjusted. For example, adjustment knob 1108 may be rotated so that it moves along piston 1110. In 1504, piston 1110 may be extended. For example, a user may pull handle 1106 with one hand and hold housing 1102 against rim 12 with the other hand. In 1505, locking mechanism 1202 is engaged. Locking mechanism 1202 may be engaged by rotating piston 1110 such that lock rods 1204 overlap with latch rods 1206. At 1506, lock 1112 may be locked. Locking lock 1112 may prevent piston 1110 from being further rotated, thus keeping locking mechanism 1202 engaged.

In an example, a user places anti-theft device 1100 over rim 12 of his automobile 10. The user positions anti-theft device 1100 such that it is centered on the outer surface of rim 12 and covers at least one lug nut 22 that secures rim 12 to automobile 10. Being placed in such a position may prevent a potential thief from being able to access lug nuts 22, and thus prevent the potential thief from removing rim 12. The user then positions security cables 1104a and 1104b such that each latching portion 1118 is positioned between spokes 24 of rim 12 and disposed adjacent the inner side of rim 12. The user then adjusts adjustment knob 1108 so that when anti-theft device 1100 is in an engaged state, anti-theft device 1100 is securely pressed against the outer surface of rim 12. The user then pulls on handle 1106 while holding housing 1102 against the outer surface of rim 12, resulting in piston 1110 being extended. The user then rotates handle 1106, thereby rotating piston 1110 and engaging locking mechanism 1202. Anti-theft device 1100 is then in an engaged stated with housing 1102 firmly pressed against the outer surface of rim 12 so that lug nuts 22 cannot be accessed. The user then locks lock 1112 so that locking mechanism 1202 cannot be disengaged.

When locking mechanism 1202 is engaged, security cables 1104a-b exert two opposing forces creating a clamp mechanism to secure anti-theft device 1100 to rim 12. On one end, cylindrical portion 1120 exerts a force toward adjustment knob 1108, which in turn exerts a force on housing 1102 toward rim 12. The second force may be exerted by latching portion 1118 toward the inner side of rim 12. The two opposing forces secure create a clamp-like mechanism that keeps housing 1102 securely pressed against rim 12.

When housing 1102 and base 1114 are a round shape, it may assist in securing anti-theft device 1100 to rim 12. Having a round-shaped housing 1102 and base 1114 may create a flush barrier between anti-theft device 1100 and rim 12. This may allow anti-theft device 1100 to be more snugly pressed against rim 12 and make it more difficult for a thief to remove anti-theft device 1100.

In addition to the embodiments described above, the present disclosure includes means for performing certain functions. For example, the disclosure includes hiding means for preventing access to one or more lug nuts 22. Hiding means, may, for example, include housing 1102 and housing 302 and the equivalents thereof. Hiding means may also include a square or rectangular plate, a circular or oblong disk, individual lug nut covers connected by a steel or other strong structure, or any other type of cover that prevents access to one or more lug nuts 22. The square or rectangular plate or the circular or oblong disk may be solid or may have a mesh pattern or other cut-outs therein which may, for example, reduce the weight of the hiding means. Hiding means includes, but is not limited to, all of the above and the equivalents thereof.

The present disclosure also includes securing means for attaching the hiding means to a rim 12. The securing means may, for example, include security cables 305 and security cables 1104a and 1104b. The securing means may also include a strap, a chain, a wire cable, a rod, an L-shaped bar, a u-shaped bar, a j-shaped bar, a t-shaped bar and any other type of member and their respective equivalents. Each of the securing means may be made of strong, break-resistant or cut-resistant material and each of the securing means may include a portion thereof capable of being connected to the hiding means and another portion capable of being connected to the rim itself. The securing means includes, but is not limited to, all of the above and their respective equivalents

The present disclosure also includes adjusting means for tightening the securing means to rim 12. The adjusting means may include locking mechanism 304 in combination with entry points 307 whereby security cables 305 are inserted into the entry points 307 and pulled tightly by the locking mechanism 304. The adjusting means may also include the piston 1110 which pulls the attached security cables 11104a and 1104b away from base 1114 thereby tightening security cables 1104a and 1104b vis-à-vis rim 12. The adjusting means may also include a ratchet, a gear, a pulley, a knob or any other device capable of pulling the distal end of securing means away from rim 12 thereby tightening the hiding means against rim 12. The adjusting means includes, but is not limited to, all of the above and their respective equivalents.

The present disclosure also includes clamping means for preventing the movement of the base 1114 away from the rim 12. The clamping means, may, for example, include locking mechanism 1202 which engages upon the rotation of piston 1110. The clamping means may also include a stationary gear interlocking with an otherwise rotatable gear, a pin inserted through a hole in piston 1110 to prevent further rotation or further axial movement, or any other mechanical or electronic device for clamping a piston 1110 from further movement once the anti-theft device 1100 is engaged. Clamping means includes, but is not limited to, all of the above and their respective equivalents

The present disclosure also includes locking means. The locking means may, for example, include the multiple embodiments of lock 303 and the multiple embodiments of lock 1112 and their respective equivalents.

The present disclosure also includes rotating means for rotatably moving the piston 1110. The rotating means may include, for example, handle 1106 connected to the top of piston 1110 as described above. The rotating means may also include a grip for hand rotation of piston 1110, a handle having holes for insertion of a tool or a portion of a hand, a battery powered motor to rotate piston 1110, or any other device that will enable the rotational movement of piston 1110. The rotating means includes, but is not limited to, all of the above and their respective equivalents.

While the present disclosure has been described in connection with the various embodiments of the various figures, it is to be understood that other similar embodiments can be used or modifications and additions can be made to the described embodiments for performing the same function of preventing or reducing the probability of theft of rims and tires. Although not every conceivable combination of components and methodologies for the purposes describing the present disclosure have been set out above, the examples provided will be sufficient to enable one of ordinary skill in the art to recognize the many combinations and permutations possible in respect of the present disclosure. Accordingly, this disclosure is intended to embrace all such alterations, modifications and variations that fall within the spirit and scope of the appended claims.

What is claimed:

1. An anti-theft apparatus for a rim, comprising:
a housing having a base, the base sized to fit over at least a portion of a hub of the rim, the housing defining a hole therethrough;
a piston positioned within the hole, the piston moveable axially and rotatably within the hole;
a security cable connected to the piston, a distal end of the security cable having a lip formed thereon, wherein the security cable moves with the axial movement of the piston;
a locking mechanism within the housing, wherein the locking mechanism is activated upon the axial movement of the piston away from the base; and
a lock connected to the locking mechanism.

2. The anti-theft apparatus of claim 1, wherein the locking mechanism is fixed upon the rotational movement of the piston.

3. The anti-theft apparatus of claim 2, further comprising a handle attached to the distal end of the piston away from the base.

4. The anti-theft apparatus of claim 1, further comprising a ring attached to the piston through cooperating threads such that a position of the piston relative to the base is adjustable.

5. The anti-theft apparatus of claim 1, wherein the lip is sized to contact the interior of a spoke.

6. The anti-theft apparatus of claim 1, further comprising a buffer material attached to the base. An anti-theft apparatus for a rim, comprising:
hiding means for covering at least one lug nut;
securing means for connecting the hiding means to the rim;
tightening means for pushing the hiding means closer to the rim; and
locking means for preventing a removal of the hiding means.

8. The anti-theft apparatus of claim 7, further comprising:
rotation means for rotatably moving the tightening means to engage a locking mechanism.

9. The anti-theft apparatus of claim 7, wherein the securing means includes a connection to the rim.

10. The anti-theft apparatus of claim 9 wherein the connection is one of a loop, a J-shaped portion, an L-shaped portion and a T-shaped portion.

11. The anti-theft apparatus of claim 7, wherein the securing means comprises security cables.

12. The anti-theft apparatus of claim 7, wherein the hiding means comprises a housing having a hole therethrough and the tightening means comprises a piston axially moveable within the hole.

13. A method for securing an anti-theft device on a rim, comprising;
positioning a cover over at least one lug nut on the rim;
securing the cover onto the rim using at least one security cable;
tightening the cover; and
engaging a locking mechanism for the cover.

14. The method of claim 13, wherein tightening the cover comprises pulling the security cable away from the rim prior to locking the cover.

15. The method of claim 13, further comprising locking the cover.
